(19) United States
(12) Patent Application Publication
(10) Pub. No.: US 2010/0318731 A1
(43) Pub. Date: Dec. 16, 2010

(54) OVERRIDE BOOT SEQUENCE BY PRESENCE OF FILE ON USB MEMORY STICK

(76) Inventor: Mark R. Murray, Atlanta, GA (US)

Correspondence Address: MERCHANT & GOULD;SCIENTIFIC ATLANTA, A CISCO COMPANY, P.O. BOX 2903, MINNEAPOLIS, MN, 55402-0903, US

(21) Appl. No.: 12/485,355

(22) Filed: Jun. 16, 2009

(51) Int. Cl. G06F 9/00; G06F 12/00

(52) U.S. Cl. 711/104; 713/2; 711/E12.001

(57) ABSTRACT

Consistent with embodiments of the present invention, systems and methods are disclosed for operating an override boot sequence. In some embodiments, a system may comprise a computing device. The computing device may contain client software configured to boot the computing device to a normal state. The computing device may further contain a first memory, wherein the client software may be stored on the first memory. The system may further comprise an interface capable of communicating with a portable memory. The portable memory may contain an override application. The system may further comprise a bootloader program associated with the computing device, wherein the bootloader device may be configured to detect the presence of a connection of the portable memory and the interface. The bootloader program may further be configured to copy the override application to a second memory associated with the computing device and execute the override application instead of the client software.

### FIELD OF THE DISCLOSURE

The present disclosure relates to overriding normal boot sequences and allowing special operations to run in place of the normal boot sequences.

### BACKGROUND

At times it may be necessary to override a normal boot sequence. For example, it may be desired for a set-top box to allow for special applications to run. However, it may be desirable to override this normal boot sequence and launch a different application. Furthermore, it may be desirable to passively load an override boot sequence without disturbing the current state of the set-top box.

### BRIEF DESCRIPTION OF THE DRAWINGS

Many aspects of the disclosure can be better understood with reference to the following drawings. The components in the drawings are not necessarily to scale. Emphasis is instead placed upon clearly illustrating the principles of the present disclosure.

FIG. 1 is a block diagram showing operating embodiments of the invention.

FIG. 2 is a flow chart illustrating operation of embodiments of the invention.

FIG. 3 is a flow chart illustrating operation of embodiments of the invention.

FIG. 4 is a block diagram of a system including a computing device.

### DESCRIPTION OF EXAMPLE EMBODIMENTS

### Overview

Consistent with embodiments of the present invention, systems and methods are disclosed for operating an override boot sequence. In some embodiments, a system may comprise a computing device. The computing device may contain client software configured to boot the computing device to a normal state. The computing device may further contain a first memory, wherein the client software may be stored on the first memory. The system may further comprise an interface capable of communicating with a portable memory. The portable memory may contain an override application. The system may further comprise a bootloader program associated with the computing device, wherein the bootloader device may be configured to detect the presence of a connection of the portable memory and the interface. The bootloader program may further be configured to copy the override application to a second memory associated with the computing device and execute the override application instead of the client software.

In some embodiments, a method may comprise the steps of: determining the presence of a portable memory; determining whether an override application may be present on the portable memory; determining whether the override application may be formatted for a computing device; copying the override application from the portable memory to a random access memory associated with the computing device; authenticating the override application; and executing the override application instead of a client application stored in permanent memory associated with the computing device.

In some embodiments, a computer-readable medium may store a set of instructions which when executed performs a method comprising: monitoring for the presence of a portable memory device at an interface associated with a set-top box capable of receiving and displaying digital data communications; detecting the presence of a valid override program on the portable memory device; and executing the override program instead of the normal boot sequence on the set-top box.

Both the foregoing general description and the following detailed description are examples and explanatory only, and should not be considered to restrict the invention's scope, as described and claimed. Further, features and/or variations may be provided in addition to those set for the herein. For example, embodiments of the invention may be directed to various feature combinations and sub-combinations described in the detailed description.

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

### DETAILED DESCRIPTION

During a normal booting sequence, a bootloader for a device may typically load locally stored client software to provide instructions for the device. For example, a set-top box may contain a bootloader which may load normal client software to configure a user's viewing experience.

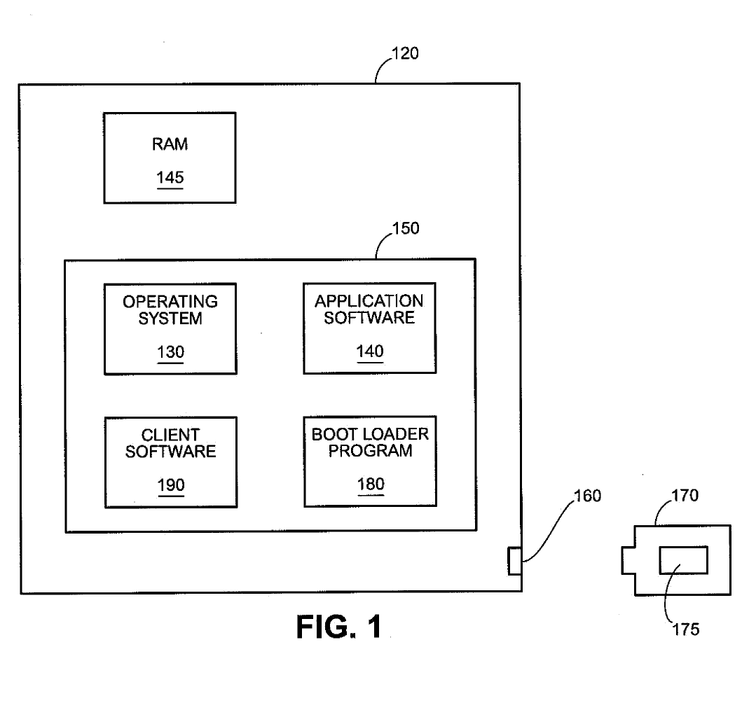

FIG. 1 illustrates an environment in which embodiments of the invention may be located. A set-top box 120 may provide a consumer interactive analog and digital transmissions. Set-top box 120 may contain an operating system 130 and application software 140 stored in a memory 150. Memory 150 may be a disk, flash memory, or any other memory capable of storing programming instructions. Set-top box 120 may further contain a Universal Serial Bus (“USB”) interface 160 capable of receiving a USB memory stick 170.

Among application software 140 may be a bootloader program 180. Bootloader program 180 may be provided to operate a boot sequence for set-top box 120. During typical operation, bootloader program 180 may load locally stored client software 190 to provide instructions for set-top box 120. For example, bootloader program 180 may load normal client software 190 to configure a user's viewing experience.

However, in situations where it may be desirable to run software different from normal client software 190, bootloader program 180 may check USB interface 160 for the presence of memory stick 170. In some embodiments, the insertion of memory stick 170 into USB interface 160 will trigger a message alerting bootloader program 180 that memory stick 170 may be present. Bootloader program 180 may then determine if an override application 175 is present on memory stick 170. Bootloader program 180 may determine if override application 175 is formatted properly for set-top box 120.

Bootloader program 180 may determine if override application 175 contains a valid digital signature. If override application 175 may be found to be properly formatted and signed, override application 175 may be copied to RAM 145 in set-top box 120. Override application 175 may then be executed without disturbing the storage state of set-top box 120.

In some embodiments, a field installer may need to activate a special configuration screen to select home installation values or options for set-top box 120. Bootloader program 180 may trigger such an activation without the need for integration into a client software stack by running override application 175 loaded from memory stick 170 to RAM 145. Override application 175 may contain instructions to activate the special configuration screen.

In some embodiments, a diagnostic application may need to run a basic functional test or a specialized test of set-top box 120 without disturbing the current software image in set-top box 120. Such a test may be easily run by an in-home technician or in the factory after the production software has been loaded by use of a properly formatted override application 175 loaded from memory stick 170 to RAM 145. Override application 175 may contain instructions to operate the diagnostic application.

In some embodiments, a cleaning application may need to be launched in order to perform a basic functional test and restore set-top box 120 back to factory defaults and erase any stored content on set-top box 120. Such a procedure may need to be run when client software becomes outdated or may not support updated features. In some embodiments, the cleaning application may be employed to refurbish a device used by a previous customer to restore the device to a factory state and subsequently provide the device to a new customer. Override application 175 may contain instructions to operate the cleaning application.

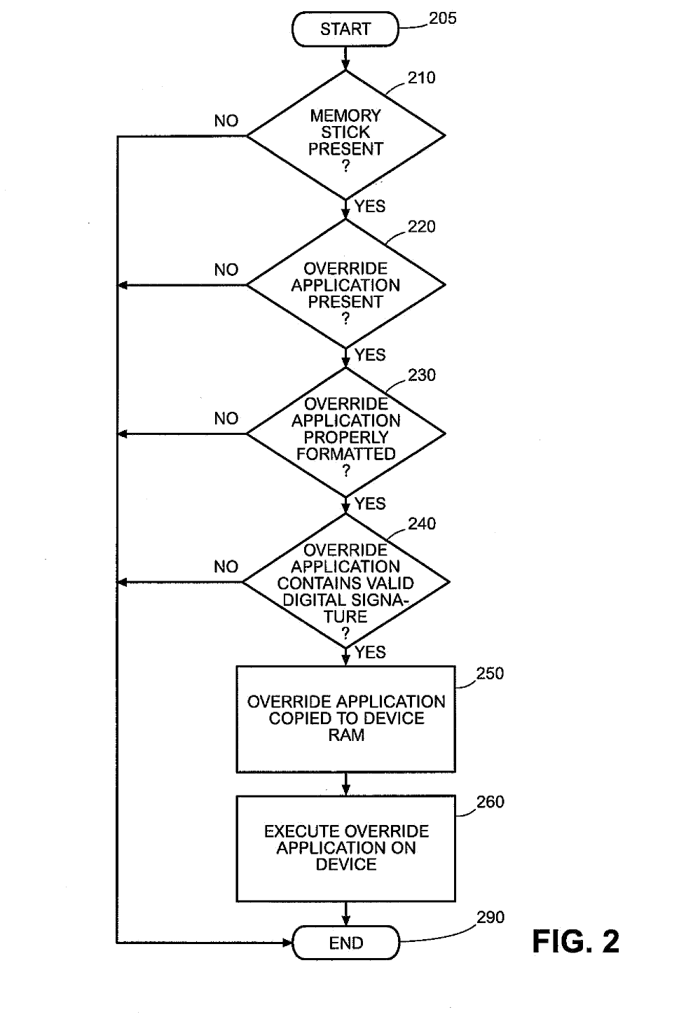

FIG. 2 illustrates a flow chart showing embodiments of the present invention. The method may start at step 205. The method may proceed to step 210 where a device determines whether or not a memory stick is present in an USB interface associated with the device. The device may be set-top box 120. However, it should be noted that in some embodiments the device may be any device requiring operation of a boot sequence. The method may then advance to step 220 where a bootloader program, for example, bootloader program 180 may determine if an override application is present on the detected memory stick. If the override application is not present on the detected memory stick, the method may end at step 290.

If the override application is present on the detected memory stick, the method may then advance to step 230 where the bootloader program may determine if the override application is formatted properly for the particular device. For example, the device may want to avoid executing instructions that may not comport with proper operation of a particular device. In some embodiments where the device may be a set-top box, it may be determined at step 230 whether the override application corresponds to the model of the set-top box. If the override application is not formatted properly for the particular device, the method may end at step 290.

If the override application is formatted properly for the particular device, the method may then advance to step 240 where the bootloader program may determine if the override application contains a valid digital signature. Usage of a digital signature may be important to prevent unauthorized override applications from being loaded which may cause security risks. If the override application does not contain a valid digital signature, the method may end at step 290.

If the override application contains a valid digital signature, the method may advance to step 250 where the override application may be copied to random access memory in the device. It should be noted that while some embodiments describe the random access memory being in the device, the random access memory may be located in an external bootloading device.

The method may then proceed to step 260 where override application 175 may then be executed without disturbing the storage contents of the device. Override application 175 may contain instructions to operate configuration programs, cleaning programs, repair programs, user interface programs, or any other program which may differ from normal client software 190. The method may then end at step 290.

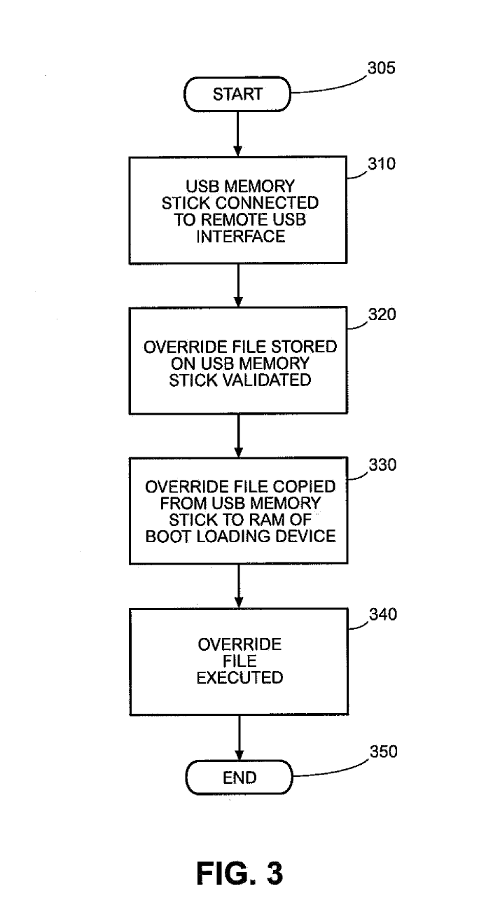

FIG. 3 illustrates a flow chart showing embodiments of the present invention. The method may start at step 305. The method may next proceed to step 310 where a portable memory device is connected to an interface capable of communicating with a computing device. In some embodiments, the interface may be located remotely from the computing device. For example, the interface may be capable of communicating to the computing device over a communications network.

The connection in step 305 may trigger a message to be sent to a bootloader program to alert the bootloader program that a portable memory device is available. The method may then proceed to step 320 where the bootloader program may act to determine and validate an override application. For example, the bootloader program may first determine whether an override application may be stored on the portable memory device. The bootloader program may then determine whether the override application may be formatted properly for the computing device. Next, the bootloader program may determine if the override application contains a valid signature recognizable by the computing device.

Once the override application may be validated in step 320, the method may proceed to step 330 where the override application may be copied from the portable memory device to a RAM memory associated with the bootloading device. Once the override application may be stored, the method may proceed to step 340 where the override file may be executed to perform instructions on the computing device instead of running the normal boot sequence of the computing device. After execution of the override application, the method may end at step 350.

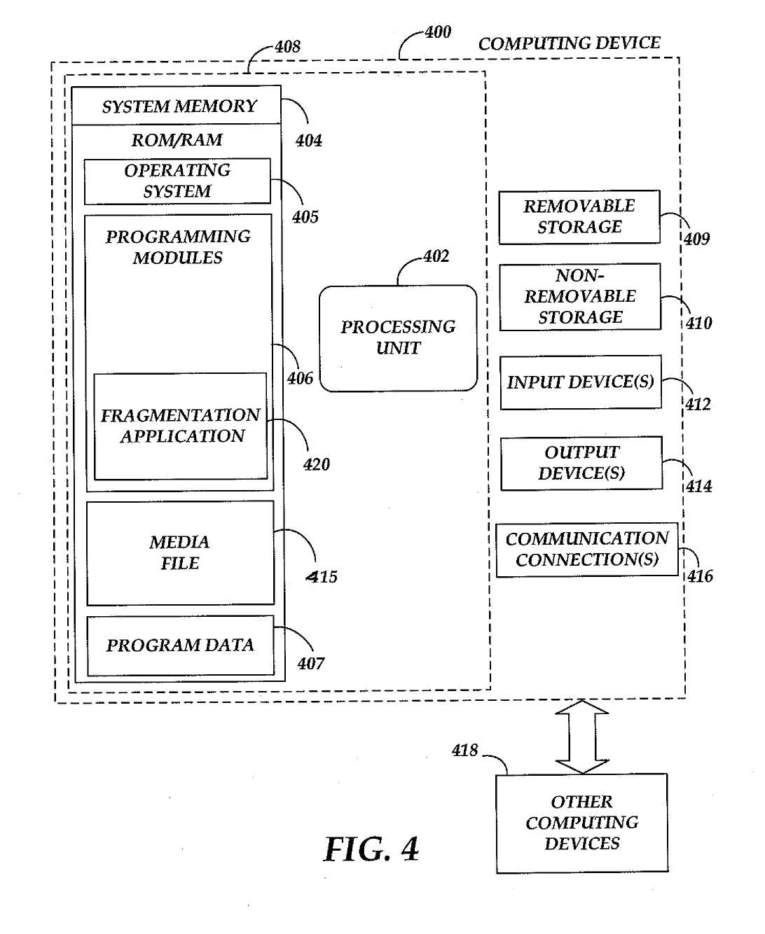

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. The described system may operate in other environments and is not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, and one or more programming modules such as a network routing service 420. Operating system 405, for example, may be suitable for controlling computing device 400's operation. In one embodiment, the programming modules may include programs that communicate via a network 410. Furthermore, embodiments of the invention may be practiced in conjunction with a graphics library, other operating systems, or any other application program and is not limited to any particular application or system.

Computing device 400 may have additional features or functionality. For example, computing device 400 may also include additional data storage devices (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. System memory 404, the removable storage, and the non-removable storage are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) such as a keyboard, a mouse, a pen, a sound input device, a touch input device, etc. Output device(s) such as a display, speakers, a printer, etc. may also be included. The aforementioned devices are examples and others may be used.

Computing device 400 may also contain a communication connection that may allow device 400 to communicate with other computing devices 418, such as over network 410 in a distributed computing environment, for example, an intranet or the Internet. The communication connection is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules (e.g. messaging application 408) may perform processes including, for example, one or more method 300's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

The methods and systems described may be embodied in any computer-readable medium for use by or in connection with an instruction execution system, apparatus, or device. Such instruction execution systems may include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example but not limited to, a system or that is based on electronic, magnetic, optical, electromagnetic, infrared, or semiconductor technology.

Specific examples of a computer-readable medium using electronic technology would include (but are not limited to) the following: random access memory (RAM); read-only memory (ROM); and erasable programmable read-only memory (EPROM or Flash memory). A specific example using magnetic technology includes (but is not limited to) a portable computer diskette. Specific examples using optical technology include (but are not limited to) compact disk (CD) and digital video disk (DVD).

Any software components illustrated herein are abstractions chosen to illustrate how functionality may partitioned among components in some embodiments disclosed herein. Other divisions of functionality may also be possible, and these other possibilities may be intended to be within the scope of this disclosure. Furthermore, to the extent that software components may be described in terms of specific data structures (e.g., arrays, lists, flags, pointers, collections, etc.), other data structures providing similar functionality can be used instead.

Any software components included herein are described in terms of code and data, rather than with reference to a particular hardware device executing that code. Furthermore, to the extent that system and methods are described in object-oriented terms, there is no requirement that the systems and methods be implemented in an object-oriented language. Rather, the systems and methods can be implemented in any programming language, and executed on any hardware platform.

Any software components referred to herein include executable code that is packaged, for example, as a standalone executable file, a library, a shared library, a loadable module, a driver, or an assembly, as well as interpreted code that is packaged, for example, as a class. In general, the components used by the systems and methods of reducing media stream delay are described herein in terms of code and data, rather than with reference to a particular hardware device executing that code. Furthermore, the systems and methods can be implemented in any programming language, and executed on any hardware platform.

The flow charts, messaging diagrams, state diagrams, and/or data flow diagrams herein provide examples of some embodiments of the present invention. Alternatively, these diagrams may be viewed as depicting actions of an example of a method implemented by some embodiments of the invention. Blocks in these diagrams represent procedures, functions, modules, or portions of code which include one or more executable instructions for implementing logical functions or steps in the process. Alternate implementations may also be included within the scope of the disclosure. In these alternate implementations, functions may be executed out of order from that shown or discussed, including substantially concurrently or in reverse order, depending on the functionality involved. The foregoing description has been presented for purposes of illustration and description. It is not intended to be exhaustive or to limit the disclosure to the precise forms disclosed. Obvious modifications or variations are possible in light of the above teachings. The implementations discussed, however, were chosen and described to illustrate the principles of the disclosure and its practical application to thereby enable one of ordinary skill in the art to utilize the disclosure in various implementations and with various modifications as are suited to the particular use contemplated. All such modifications and variation are within the scope of the disclosure as determined by the appended claims when interpreted in accordance with the breadth to which they are fairly and legally entitled.

What is claimed is:

1. A system comprising:
a computing device;
client software configured to boot the computing device to a normal state;
a first memory associated with the computing device, wherein the client software is stored on the first memory;
an interface capable of communicating with a portable memory;
an override application stored on the portable memory;
a bootloader program associated with the computing device, wherein the bootloader device is configured to detect the presence of a connection of the portable memory and the interface; and
the bootloader program further configured to copy the override application to a second memory associated with the computing device and execute the override application instead of the client software.

2. The system of claim 1, wherein the computing device is a device capable of receiving and displaying audio and video transmissions.

3. The system of claim 1, wherein the computing device is a set-top box.

4. The system of claim 1, wherein the bootloader program copies the override application to the second memory associated with the computing device and executes the override application instead of the client software without user input.

5. The system of claim 1, wherein the interface is a USB interface.

6. The system of claim 5, wherein the portable memory device is a USB memory stick.

7. The system of claim 1, wherein the second memory is random access memory.

8. A method comprising:
determining the presence of a portable memory;
determining whether an override application is present on the portable memory;
determining whether the override application is formatted for a computing device;
copying the override application from the portable memory to a random access memory associated with the computing device; and
executing the override application instead of a client application stored in permanent memory associated with the computing device.

9. The method of claim 8, further comprising:
determining whether the override application contains a valid digital signature.

10. The method of claim 8, wherein executing the override application further comprises running a diagnostic program on the computing device.

11. The method of claim 8, wherein determining the presence of a portable memory further comprises alerting the computing device when the portable memory is connected to an interface capable of communication with the computing device.

12. The method of claim 11, wherein the portable memory is a USB memory stick and the interface is a USB interface.

13. The method of claim 8, wherein the computing device is a set-top box.

14. The method of claim 13, wherein executing the override application further comprises running a configuration program on the set-top box.

15. The method of claim 8, wherein copying the override application from the portable memory to a random access memory associated with the computing device further comprises copying the override application across a communications network.

16. A computer-readable medium which stores a set of instructions which when executed performs a method comprising:
monitoring for the presence of a portable memory device at an interface associated with a set-top box capable of receiving and displaying digital data communications;
detecting the presence of a valid override program on the portable memory device; and
executing the override program instead of the normal boot sequence on the set-top box.

17. The computer-readable medium of claim 16, wherein the override program operates to provide a configuration screen to select installation options for the set-top box.

18. The computer-readable medium of claim 16, wherein the override program operates to run testing software without disturbing the client software stack associated with the set-top box.

19. The computer-readable medium of claim 16, wherein the override program operates to restore the set-top box to factory default settings.

20. The computer-readable medium of claim 16, wherein detecting the presence of a valid override program on the portable memory device further comprises:
determining whether the override application is formatted for a computing device; and
determining whether the override application contains a valid digital signature.
